(19) United States
(12) Patent Application Publication
(10) Pub. No.: US 2025/0349100 A1
(43) Pub. Date: Nov. 13, 2025

(54) INFORMATION PROCESSING APPARATUS, INFORMATION PROCESSING METHOD, AND MEDIUM

(71) Applicant: CANON KABUSHIKI KAISHA, Tokyo (JP)

(72) Inventors: YASUHIRO OKUNO, Tokyo (JP); YUICHI KAGEYAMA, Kanagawa (JP)

(21) Appl. No.: 19/198,566

(22) Filed: May 5, 2025

(30) Foreign Application Priority Data
May 7, 2024 (JP) 2024-075283

(51) Int. Cl. G06V 10/25; G06V 10/26; G06V 10/774; G06V 10/776; G06V 10/82

(52) U.S. Cl. CPC G06V 10/25; G06V 10/26; G06V 10/774; G06V 10/776; G06V 10/82; G06V 2201/07

(57) ABSTRACT

An information processing apparatus includes at least one processor and at least one memory that is in communication with the at least one processor. The at least one memory stores instructions for causing the at least one processor and the at least one memory to train a neural network to detect target areas in images using training data, acquire object areas containing the detection target from the training data, set a weighting area based on these object areas, calculate a loss value based on the difference between the neural network's detection results and the training data. A second weight is applied to differences within the weighting area to calculate the loss value, causing the loss value to be larger than when using a first weight applied to differences outside this area, and the neural network is trained based on this loss value.

### BACKGROUND

### Field

The present disclosure relates to an information processing technique for training a neural network.

### Description of the Related Art

There is known a detection technique for detecting an area of a specific object or the like from an image. The detection technique is used, for example, for face detection by setting a face of a person as a detection target and detecting a face area from an image in which a person and the like are present. Then, a face detection result is used for face recognition and autofocus processing when an image capturing is performed. Further, in recent years, a technique using a neural network for detecting an object or the like has been developed. “CenterNet: Keypoint Triplets for Object Detection, Kaiwen Duan, Song Bai, Lingxi Xie, Honggang Qi, Qingming Huang, Qi Tian; ICCV2019, pp. 6569-6578” discusses a method of detecting an object by using a neural network trained to output a key point indicating an object position of a detection target as a heat map. Further, “Training Region-based Object Detectors with Online Hard Example Mining, A. Shrivastava, A. Gupta and R. Girshick, CVPR2016, pp. 761-769” discusses a method of training a neural network to suppress erroneous detections when the training of the neural network for the object detection is performed. More specifically, “Training Region-based Object Detectors with Online Hard Example Mining, A. Shrivastava, A. Gupta and R. Girshick, CVPR2016, pp. 761-769” discusses a technique of selecting a partial image of an area erroneously detected from a training image as a hard negative sample (negative case sample that is difficult to learn), and repeatedly performing the training using the hard negative sample.

However, with the conventional detection techniques described above, an area that is not the detection target is often detected erroneously. In the method discussed in “Training Region-based Object Detectors with Online Hard Example Mining, A. Shrivastava, A. Gupta and R. Girshick, CVPR2016, pp. 761-769”, an attempt is made to suppress erroneous detections by focusing on learning parts that are erroneously detected during training. However, efficient training that can sufficiently suppress erroneous detections has not yet been achieved.

### SUMMARY

In view of the above, embodiments of the present disclosure are directed to a technique for enabling efficient training that can suppress the occurrence of erroneous detections.

According to an aspect of the present disclosure, an information processing apparatus includes at least one processor and at least one memory that is in communication with the at least one processor. The at least one memory stores instructions for causing the at least one processor and the at least one memory to train a neural network for detecting an area of a detection target from an image using training data, acquire an object area including the detection target as a region from the training data, set a weighting area based on the object area including the detection target as a region, and acquire a loss value based on a difference between a detection result by the neural network for the training data and the training data, wherein, with regard to the difference between the detection result by the neural network and the training data, a second weight is applied to the difference in the weighting area to calculate the loss value, the second weight causing the loss value to be larger than a first weight applied to the difference outside the weighting area, and wherein training of the neural network is performed based on the loss value.

Further features of various embodiments of the present disclosure will become apparent from the following description of exemplary embodiments with reference to the attached drawings.

### BRIEF DESCRIPTION OF THE DRAWINGS

FIG. 1 is a block diagram illustrating a configuration example of an information processing apparatus.

FIG. 2 is a flowchart illustrating training processing.

FIGS. 3A, 3B, 3C, 3D, 3E, and 3F are diagrams each illustrating a map.

FIG. 4 is a flowchart illustrating loss value calculation processing.

FIG. 5 is a flowchart illustrating target detection processing.

FIG. 6 is a flowchart illustrating area division processing according to a second exemplary embodiment.

### DESCRIPTION OF THE EMBODIMENTS

Hereinafter, exemplary embodiments will be described with reference to the drawings. The exemplary embodiments described below do not limit every embodiment, and all of the plurality of features described in the exemplary embodiments are not necessarily essential to the solving means of the present disclosure, and the plurality of features may be freely combined. A configuration of each exemplary embodiment can be appropriately modified or changed according to the specification and various conditions (use conditions, use environments, and the like) of an apparatus to which the present disclosure is applied. Further, a part of each exemplary embodiment described below may be appropriately combined. In the following exemplary embodiments, the same or similar configurations and processing steps are denoted by the same reference numerals, and redundant description will be omitted.

Before describing a configuration and processing of an information processing apparatus according to exemplary embodiments, factors that can cause erroneous detections when a specific detection target area is detected from an image will be described. As a result of analyzing various erroneous detections that occurred when a detection target area was detected, the inventors of the present disclosure found that an area other than the detection target area on the same object was sometimes erroneously detected as the detection target in a case where a region of the object was the detection target. Further, the inventors of the present disclosure found that the conventional detection techniques described above could not sufficiently suppress the erroneous detections of detecting an area other than the detection target area on the same object as the detection target. Then, the inventors of the present disclosure could estimate the following factors as a result of considering the factors that contribute to the occurrence of erroneous detections on the same object including the detection target as a region.

Specifically, the inventors of the present disclosure could estimate that one of the factors in erroneously detecting another area on the same object including the detection target as a region was that, in many cases, the other area similar to the detection target in feature was present on the same object including the detection target as a region. For example, in a case of detecting a detection target using a neural network, at a training time of the neural network, learning of a feature or the like of the detection target is performed. For example, in a case where the detection target is a face, features of the skin and the hair on the head are also learned as the features of the face. On the other hand, since a human body includes many areas having features similar to those of the face (e.g., hair, and skin areas of hands, feet, neck, and body), such areas having the similar features are sometimes detected erroneously as a face area. Further, at the time of training the neural network, the features such as colors, patterns, and designs around the detection target are also learned at the same time. However, the periphery of the same object including the detection target as a region is similar to the periphery of the detection target in many cases. For example, in a case where the detection target is a face, since the face is a region adjacent to a body, it is also learned that the features of the body are present in the periphery of the face. In this way, in the periphery of the body, since another area having features similar to the features of the face is present, the area may be erroneously detected as the face. Further, the erroneous detection similar to the one described above is likely to occur not only in the case where a person's face is the detection target but also in a case where face portions of various kinds of animals, such as mammals, birds, and reptiles, are the detection targets. More specifically, in the case where the face portions of the animals are the detection targets, since the faces thereof are covered with fur or feathers and bodies thereof are also covered with fur or feathers in many cases, erroneous detections may occur on the bodies of the animals.

A detection result with regard to the detection target described above may be used to control autofocus of an image capturing apparatus, such as a camera. In a case where image capturing is performed using the image capturing apparatus, because the detection target is selected in advance in accordance with an object desired to be captured before capturing an image, the object including the detection target is usually captured in the image. For example, in a case where an image of a person's face is to be captured, an image of the person's body including the face is often captured, and since the same object (person's body) including the detection target (face) as a region is captured in the image, an erroneous detection is unlikely to occur on the same object including the detection target as a region as described above.

Thus, the information processing apparatus according to the present exemplary embodiment trains a neural network so that the erroneous detections on the same object including the detection target as a region are preferentially and strongly suppressed over other erroneous detections. In the present exemplary embodiment, an example in which a person's face area is detected as the detection target will be described. As a matter of course, this is just one example, and the detection target is not limited to the face. The detection target may be regions on various objects, such as a face of an animal, and such as pupils of a person and an animal.

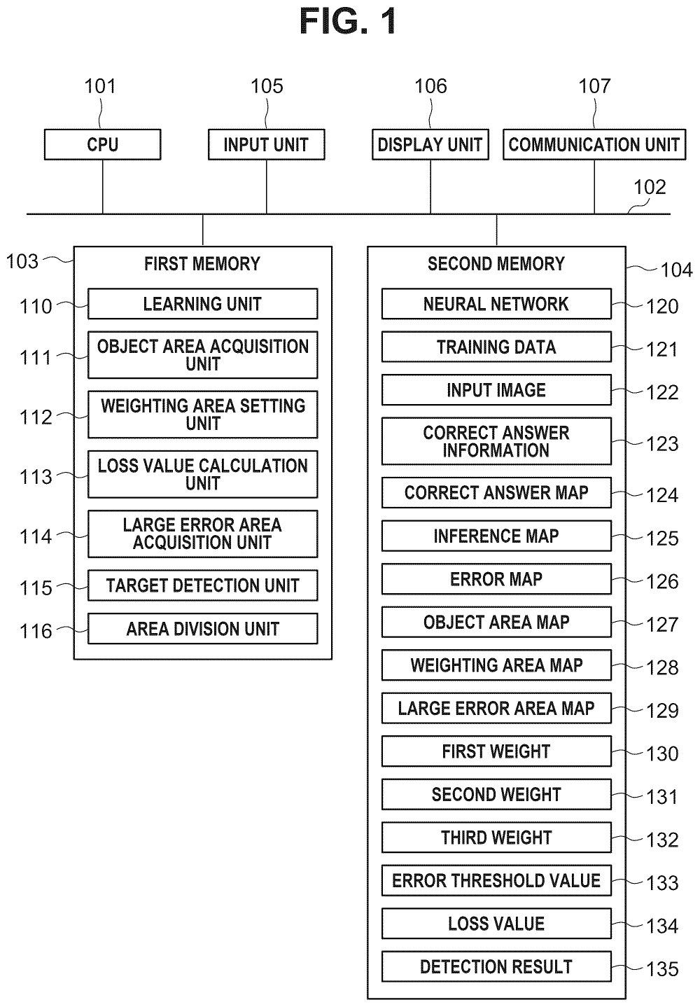

FIG. 1 is a block diagram illustrating a configuration example of an information processing apparatus according to a first exemplary embodiment.

A central processing unit (CPU) 101 controls the entire information processing apparatus according to the present exemplary embodiment. Further, the CPU 101 executes an information processing program according to the present exemplary embodiment.

An input unit 105 includes, for example, a keyboard, a mouse, a touch panel, and/or the like, to receive input from a user.

A display unit 106 includes a liquid crystal display or the like, and displays a processing result by the CPU 101 to the user.

A communication unit 107 communicates with other apparatuses to transmit and receive data.

In the information processing apparatus, the components described above are connected with each other via a computer bus 102.

A first memory 103 and a second memory 104 are memories for storing an information processing program for the CPU 101 to implement the information processing according to the present exemplary embodiment and for storing various kinds of data.

FIG. 1 illustrates an example in which the first memory 103 mainly stores the information processing program according to the present exemplary embodiment, and the second memory 104 mainly stores various kinds of data used by the information processing program according to the present exemplary embodiment. As a matter of course, the present exemplary embodiment is not limited to this example.

The information processing program according to the present exemplary embodiment is a program executed by the CPU 101 to implement functions of functional units including a learning unit 110, an object area acquisition unit 111, a weighting area setting unit 112, a loss value calculation unit 113, a large error area acquisition unit 114, and a target detection unit 115. FIG. 1 illustrates the functional units implemented on the first memory 103 by the CPU 101 executing the information processing program according to the present exemplary embodiment, as the learning unit 110 to the target detection unit 115. Details of the learning unit 110 to the target detection unit 115 will be described below. Note that an area division unit 116 in the first memory 103 is a functional unit to be described below in a second exemplary embodiment and is a component not used in the first exemplary embodiment, but for simplification of the drawings, it is illustrated in FIG. 1.

The target detection unit 115 detects a specific detection target area from an image using a neural network 120. Details of target detection processing performed by the target detection unit 115 will be described below.

The learning unit 110 trains the neural network 120 to be used when the target detection unit 115 detects the detection target from the image, using training data. Details of training processing performed by the learning unit 110 will be described below.

The object area acquisition unit 111 acquires an object area, including the detection target as a region, based on the training data in a case where the training of the neural network 120 is performed. Details of object area acquisition processing performed by the object area acquisition unit 111 at the time of training the neural network 120 will be described below.

The weighting area setting unit 112 sets a weighting area for an erroneous detection at the time of training the neural network 120 based on the object area acquired by the object area acquisition unit 111 at the time of training the neural network 120, i.e., based on the object area including the detection target as a region. Details of weighting area setting processing performed by the weighting area setting unit 112 at the time of training the neural network 120 will be described below.

The large error area acquisition unit 114 acquires, as a large error area, an area with a strength of an erroneous detection larger than a predetermined threshold value in the weighting area set by the weighting area setting unit 112 at the time of training the neural network 120. Details of large error area acquisition processing performed by the large error area acquisition unit 114 at the time of training the neural network 120 will be described below.

In a case where the training of the neural network 120 is performed, the loss value calculation unit 113 calculates a loss value based on an error (difference) between (i) the detection result of the target detection unit 115 with regard to the training data and (ii) the training data. Details of loss value acquisition processing performed by the loss value calculation unit 113 at the time of training the neural network 120 will be described below.

The neural network 120, training data 121, an input image 122, correct answer information 123, a correct answer map 124, an inference map 125, an error map 126, an object area map 127, a weighting area map 128, a large error area map 129, a first weight 130, a second weight 131, a third weight 132, an error threshold value 133, a loss value 134, and a detection result 135 in the second memory 104 are various kinds of data used when the information processing program is executed.

The neural network 120 is configured to generate and output a map having a value at each position therein at which a detection target is detected from the input image 122. The target detection unit 115 described above detects the detection target area from the input image 122 using the neural network 120.

The map generated by the neural network 120 is stored in the second memory 104 as the inference map 125. For simplification of description, the size of the inference map 125 is assumed to be the same as the size of the input image 122, but the neural network 120 may be configured so that the size of the inference map 125 is a predetermined magnification with respect to the input image 122.

The training data 121 and the correct answer information 123 are prepared in advance and stored in the second memory 104. The correct answer information 123 is information included in the training data 121, and the training data 121 includes a plurality of images for training together with the training data 121. The plurality of images for training includes an image obtained by capturing a detection target, an image obtained by capturing an object including the detection target as a region, an image obtained by capturing an object not including the detection target, and an image including neither the detection target nor the object. The correct answer information 123 is information indicating a position and a size of the detection target in the image in the training data 121. In the training data 121, each image and the correct answer information 123 indicating the position and the size of the detection target in the corresponding image are associated with each other and stored. In FIG. 1, the example in which the training data 121 and the correct answer information 123 are separately stored in the second memory 104 is illustrated, but they may be stored together. In addition, the correct answer information 123 is not limited to the information about the position and the size of the detection target in each image in the training data 121, and the correct answer information 123 may also include other information. The training data 121 and the correct answer information 123 may be acquired from an external apparatus via the communication unit 107 and stored in the second memory 104.

The first weight 130, the second weight 131, the third weight 132, and the error threshold value 133 are also prepared in advance and stored in the second memory 104. However, they are not limited thereto, and the first weight 130, the second weight 131, the third weight 132, and the error threshold value 133 may be dynamically adjusted at the time of training depending on a training status. Details of use applications of the first weight 130, the second weight 131, the third weight 132, and the error threshold value 133 will be described below.

Details of the input image 122, the correct answer map 124, the inference map 125, the error map 126, the object area map 127, the large error area map 129, the loss value 134, and the detection result 135 stored in the second memory 104 will be described below.

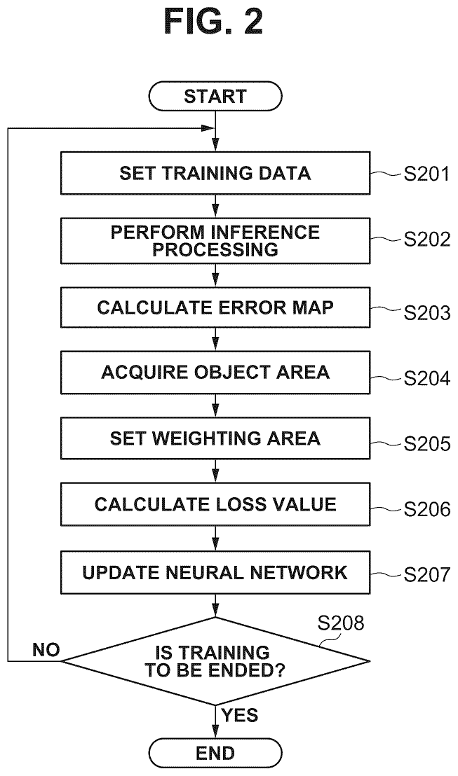

FIG. 2 is a flowchart illustrating a flow of information processing performed when the training of the neural network 120 is performed in the information processing apparatus according to the present exemplary embodiment. Processing steps illustrated in the flowchart in FIG. 2 are processing performed by functional units implemented by the CPU 101 executing the information processing program according to the present exemplary embodiment, i.e., the functional units configured in the first memory 103.

First, in step S201, the learning unit 110 reads the training data 121 and the correct answer information 123 stored in the second memory 104, and the learning unit 110 sets them to the neural network 120. The learning unit 110 sets an image in the training data 121 to the neural network 120 as the input image 122. Further, the learning unit 110 generates the correct answer map 124 based on the correct answer information 123. For example, the learning unit 110 generates a heat map having the same size as an image based on the position and the size of a detection target on the image in the training data 121 associated with the correct answer information 123, and the learning unit 110 sets the heat map as the correct answer map 124. Then, the learning unit 110 stores the generated correct answer map 124 in the second memory 104.

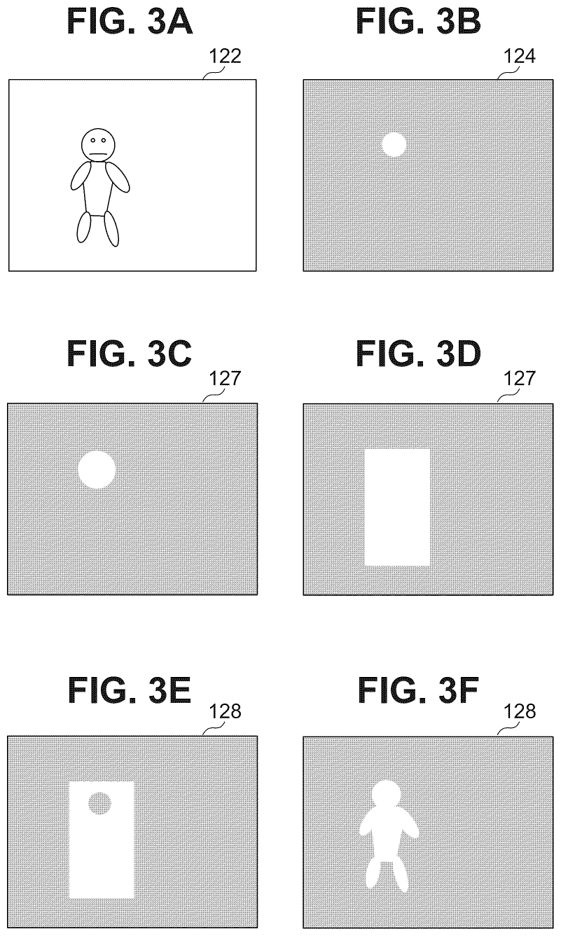

FIG. 3A is a diagram illustrating an example of the input image 122 read from the training data 121 and set to the neural network 120, and FIG. 3B is a diagram illustrating an example of the correct answer map 124 generated with respect to the input image 122 in FIG. 3A. In the present exemplary embodiment, the correct answer map 124 is a binary map having a value “1” at each position in an image area in which the detection target is present and having a value “0” at each position in an area other than the image area. In the present exemplary embodiment, an example in which a person's face is the detection target is described, and the correct answer information 123 corresponding to the input image 122 with a person captured therein as illustrated in FIG. 3A is position information and size information of the person's face. Accordingly, as illustrated in FIG. 3B, the correct answer map 124 becomes a map having a value 1 at each position in a circular area with the position information of the correct answer information 123 as the center and having a diameter indicated by the size information. However, the correct answer map 124 is not limited to this example, and, for example, the correct answer map 124 may be a multi-value map having a maximum value at the position of the detection target and values that gradually decrease as the distance from the position of the detection target increases. Further, the area with the value “1” at each position is not limited to the circular area, and, for example, may be a rectangular area or a free-form area.

After step S201, the learning unit 110 performs training of the neural network 120 using information to be acquired in step S202 and subsequent steps. More specifically, the learning unit 110 performs the training so as to update weighting parameters of the neural network 120 so that a map similar to the correct answer map 124 is output when the input image 122 is input to the neural network 120.

In step S202, the learning unit 110 inputs the input image 122 to the neural network 120 to acquire the inference map 125 generated by inference processing (feed-forward processing) of the neural network 120. Then, the learning unit 110 stores the inference map 125 in the second memory 104.

Next, in step S203, the learning unit 110 calculates a difference between the inference map 125 and the correct answer map 124, i.e., an error of the inference map 125 with respect to the correct answer map 124, and the learning unit 110 stores the difference (error) in the second memory 104 as the error map 126.

Next, in step S204, the object area acquisition unit 111 acquires an area of the object including the detection target as a region in the input image 122. In the case of the present exemplary embodiment, the object area acquisition unit 111 acquires the area of the object including the detection target as a part based on the correct answer information 123 corresponding to the image in the training data 121 set as the input image 122, not detecting the object area directly from the input image 122. In the present exemplary embodiment, because the detection target is a face, the area of the same object including the face as the region is, for example, a head area and a body area of the person. Then, the object area acquisition unit 111 generates the object area map 127 representing the area of the object including the acquired detection target as a region, and the object area acquisition unit 111 stores the generated object area map 127 in the second memory 104. In the present exemplary embodiment, the object area map 127 is a binary map having a value “1” at each position in an image in which an object including the detection target as a region is present and having a value “0” at each position in the image other than positions each having the value “1”.

Hereinbelow, the object area acquisition processing performed by the object area acquisition unit 111 in step S204 will be described.

The object area acquisition unit 111 according to the present exemplary embodiment acquires the object area representing the area of the object including the detection target as a region using, as parameters, the position and the size of the detection target included in the correct answer information 123 corresponding to the image in the training data 121 set as the input image 122. Then, the object area acquisition unit 111 generates the object area map 127 representing the acquired object area, and the object area acquisition unit 111 stores the generated object area map 127 in the second memory 104. In the case of the present exemplary embodiment, the object area acquisition unit 111 acquires the object area to generate the object area map 127 using any one of a first object area acquisition method, a second object area acquisition method, and a third object area acquisition method exemplified below.

The first object area acquisition method is a method of acquiring an area that is wider than the area with the position indicated by the position information of the detection target included in the correct answer information 123 as the center and that is represented by the size information included in the correct answer information 123. As exemplified in the present exemplary embodiment, in the case where the detection target is a person's face, the first object area acquisition method acquires, as the object area, an area that is wider than a face area with the face area as the center. The area that is wider than the area represented by the size information included in the correct answer information 123 is, for example, an area having a size obtained by multiplying the area represented by the size information by a predetermined magnification ratio. Further, in the case of the present exemplary embodiment, as described above, because the case in which the area having the value “1” at each position in the correct answer map 124 is the circular area is exemplified, the object area is also set to a circular area.

FIG. 3C is a diagram illustrating an example of the object area map 127 acquired using the first object area acquisition method in the example illustrated in FIGS. 3A and 3B. When the object area map 127 illustrated in FIG. 3C and the correct answer map 124 illustrated in FIG. 3B are compared, while the center positions of the circular areas are the same, the diameter of the circular area of the object area map 127 is larger than that of the correct answer map 124.

Then, in a case where the first object area acquisition method is used, the learning unit 110 performs training so as to suppress the occurrence of erroneous detections in the circular area represented by the object area map 127. In other words, the learning unit 110 performs learning of the neural network 120 capable of suppressing the occurrence of erroneous detections in the circular area in the object area map 127 located at the same position as that in the correct answer map 124 and with the diameter larger than that in the correct answer map 124. In this way, the neural network 120 capable of suppressing another area from being erroneously detected on the same object including the detection target as a region can be obtained, and, for example, in a case where a face is the detection target, it is possible to suppress the occurrence of an erroneous detection of detecting, for example, areas such as the person's hair and ears and an area near the face as the face area.

The second object area acquisition method is a method of acquiring an object area including another area inferred from the position of the area of the detection target in addition to the area of the detection target, using, as variables, the position and the size of the detection target included in the correct answer information 123. The second object area acquisition method acquires the area having a predetermined positional relationship relative to the position of the detection target included in the correct answer information 123 and having a size relationship proportional to the size of the detection target as the object area including the detection target. For example, in the case where the detection target is a face, the second object area acquisition method acquires an object area including not only the face area but also an area of the body or the like having the predetermined positional relationship relative to the position of the face and having the size relationship of being larger than and proportional to the size of the face.

FIG. 3D is a diagram illustrating an example of the object area map 127 acquired using the second object area acquisition method in the example illustrated in FIGS. 3A and 3B. For example, in the case where the detection target is a face, in general, there is a positional relationship that the body is located lower than the face, and while the body is an area larger than the face in size, there is a proportional relationship to some extent between the size of the body and the size of the face. Thus, the second object area acquisition method acquires, as the object area, a rectangular area that includes the face area, is located lower than the face area, and covers an area of the body that is larger than the face area, and acquires the object area map 127 corresponding to the rectangular object area.

Then, in a case where the second object area acquisition method is used, the learning unit 110 performs learning so as to suppress the occurrence of erroneous detections in the object area (rectangular area) represented by the object area map 127.

In other words, the learning unit 110 performs training of the neural network 120 capable of suppressing the occurrence of erroneous detections in the rectangular area of the object area map 127. In this way, the neural network 120 capable of suppressing another area from being erroneously detected on the same object including the detection target as a region can be obtained. For example, in a case where the detection target is a person's face, it is possible to suppress the occurrence of an erroneous detection of detecting, as the face area, an area of the person's body (e.g., an area of the person's neck, chest, arms, hands, or an item held in the person's hand). There may be a case where the correct answer information 123 includes information about, for example, the body area and limb area in addition to the position and the size of the face. In such a case, the object area may be obtained in a similar manner to the method described above also using the information about the body area and the limb area.

The third object area acquisition method is a method of preparing in advance object area data, for example, the object area map 127 including the detection target as a region, as data related to the correct answer information 123 of the training data 121. In the case of the third object area acquisition method, the object area can be acquired by reading the object area data (object area map 127) prepared in advance in relation to the correct answer information 123.

The description returns to the flowchart in FIG. 2.

After the object area acquisition processing described above in step S204, the processing proceeds to step S205. In step S205, the weighting area setting unit 112 sets the weighting area to generate the weighting area map 128, and the weighting area setting unit 112 stores the generated weighting area map 128 in the second memory 104. In the present exemplary embodiment, the weighting area setting unit 112 generates a map, as the weighting area map 128, in which each map value in the object area map 127 corresponding to a position having a map value “1” in the correct answer map 124 is set to “0”. In other words, the weighting area map 128 is a map obtained by subtracting the detection target area from the area of the object including the detection target as a region.

FIG. 3E is a diagram illustrating an example of the weighting area map 128 generated by the weighting area setting unit 112 in the examples illustrated in FIGS. 3A, 3B, and 3D.

More specifically, the weighting area map 128 illustrated in FIG. 3E is a map generated by setting the map values corresponding to the positions each with the map value “1” on the correct answer map 124 to “0” with respect to the object area map 127 illustrated in FIG. 3D.

After the weighting area setting processing in step S205, the processing proceeds to step S206. In step S206, the loss value calculation unit 113 calculates the loss value 134 based on the error map 126 and the weighting area map 128.

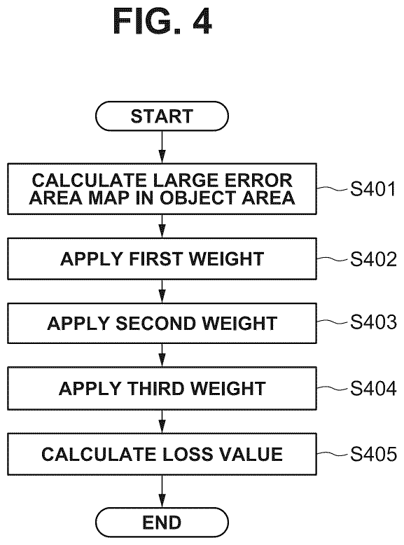

FIG. 4 is a flowchart illustrating the loss value calculation processing by the loss value calculation unit 113 and processing related thereto.

In the present exemplary embodiment, the loss value calculation unit 113 calculates the loss value 134 after weighting an error value (difference between the inference map 125 and the correct answer map 124) at each position in the error map 126 based on the weighting area map 128. In the present exemplary embodiment, before calculating the loss value 134, in step S401, the large error area acquisition unit 114 performs processing of generating the large error area map 129 as the information used for weighting based on the weighting area map 128. The large error area map 129 is generated by the large error area acquisition unit 114.

The large error area acquisition unit 114 generates a map in which values at positions in the error map 126 corresponding to the positions each with a map value “1” in the weighting area map 128 become “1” at positions in an area each with a predetermined error threshold value or more, and become “0” at positions in an area each with a value less than the predetermined error threshold value. In addition, the predetermined error threshold value is the error threshold value 133 prepared in advance in the second memory 104. In other words, the large error area refers to an area with a high degree of erroneous detection in which each value in the error map 126 is greater than or equal to the threshold value.

In other words, the large error area is an area from which the values of the inference map 125 are output as values larger than or equal to the threshold value at positions each with the value “0” in the correct answer map 124. Then, the large error area acquisition unit 114 stores the generated map in the second memory 104 as the large error area map 129 in the object area.

Next, in step S402, the loss value calculation unit 113 multiplies, by the first weight 130 in the second memory 104, the error values of the area with the value “0” in the weighting area map 128 from among the error values at the positions of the error map 126. In other words, the loss value calculation unit 113 applies the first weight 130 to the error values of the area other than the weighting area from among the positions of the error map 126.

Next, in step S403, the loss value calculation unit 113 multiplies, by the second weight 131 in the second memory 104, the error value of the area with the value “1” at each position in the weighting area map 128 and with the value “0” at each position in the large error area map 129 among the error values at positions in the error map 126. Assume that the second weight 131 is larger than the first weight 130. More specifically, the loss value calculation unit 113 applies the second weight 131, which is larger than the first weight 130, to the error values in the weighting area among the error values at the positions in the error map 126.

Next, in step S404, the loss value calculation unit 113 multiplies, by the third weight 132 in the second memory 104, the error value at each position in the area with the value “1” in the weighting area map 128 and with the value “1” in the large error area map 129 among the error values at the positions in the error map 126. Assume that the third weight 132 is larger than the second weight 131. More specifically, the loss value calculation unit 113 applies the largest weight (third weight 132) to the error values of the large error area in the weighting area among the error values at the positions in the error map 126.

Then, in step S405, the loss value calculation unit 113 calculates the loss value 134 based on the error map 126 weighted through the processing up to the step S404, and the loss value calculation unit 113 stores the calculated loss value 134 in the second memory 104. In the training in which a correct answer is given in a map format as in the present exemplary embodiment, the training is generally performed by setting a sum total of cross entropies between the correct answer map 124 and the inference map 125 as a loss. Thus, the loss value calculation unit 113 weights the error map 126, which is an error between the correct answer map 124 and the inference map 125, for each area to calculate a loss value weighted for each area.

As described above, in the loss value calculation processing according to the present exemplary embodiment, it is possible to perform different weighting inside and outside the area of the same object including the detection target as a region, and it is further possible to perform weighting based on the strength of the error inside the object area. In this way, it is possible to train the neural network 120 capable of efficiently suppressing erroneous detections.

In addition, while the example in which the magnitude of the weighting is divided into three levels and the weighting area is divided into three is described above, it is not limited thereto. For example, the loss value calculation unit 113 may divide the magnitude of the weighting into two levels and divide a weighting area into two areas to calculate the loss value 134 without performing the large error area acquisition processing in the object area in step S401 and the weighting by the third weight 132 in step S404. In this case, only the weighting different between the inside and the outside of the object area including the detection target as a region is performed, but even in this case, it is possible to preferentially suppress an erroneous detection occurring inside the object area including the detection target as a region.

The description returns to the flowchart in FIG. 2 again.

After the loss value calculation processing in step S206, the processing proceeds to step S207. In step S207, the learning unit 110 updates the weighting parameters of the neural network 120 using a back propagation based on the loss value 134 calculated in step S206. The training method of the neural network using the back propagation is a commonly known technique, and the description thereof is omitted.

Next, in step S208, the learning unit 110 determines whether to end the training of the neural network. For example, the learning unit 110 determines to end the training in a case where the update of the neural network is performed a predetermined number of times. Also, the learning unit 110 may determine to end the training in a case where the loss value 134 becomes lower than a predetermined value. In a case where the learning unit 110 determines to end the training (YES in step S208), the learning unit 110 ends the processing of the flowchart in FIG. 2. On the other hand, in a case where the learning unit 110 determines not to end the learning (NO in step S208), the learning unit 110 returns the processing to step S201, and performs the training processing similar to that described above using data different from the data already used in the training data 121.

Next, the target detection processing performed in the target detection unit 115 according to the first exemplary embodiment will be described.

The processing described below is processing of detecting the detection target area from an unknown input image using the neural network 120 trained by the learning unit 110 described above.

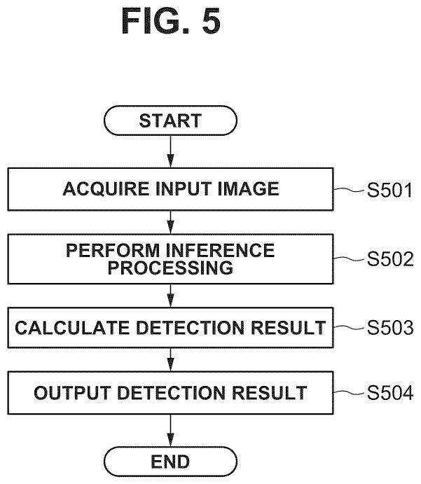

FIG. 5 is a flowchart illustrating a flow of the target detection processing by the target detection unit 115.

First, in step S501, the target detection unit 115 acquires an unknown input image, and the target detection unit 115 stores the acquired unknown input image in the input image 122 in the second memory 104. Assume that the unknown input image is an image received from an external apparatus via, for example, the input unit 105 or the communication unit 107 in FIG. 1, not the image in the training data 121 described above.

Next, in step S502, the target detection unit 115 inputs the input image 122 to the trained neural network 120 described above to perform inference processing thereon, and the target detection unit 115 stores the inference map 125 obtained by the inference processing in the second memory 104.

Next, in step S503, the target detection unit 115 calculates the position and the size of the detection target based on the inference map 125. The inference map 125 is a map in which map values are high at positions at which the detection target is present and are low at positions other than these positions, and the inference map 125 ideally is a map similar to the correct answer map 124 illustrated in FIG. 3A. Then, the target detection unit 115 calculates a bounding box surrounding a part with map values higher than a predetermined threshold value that is separately determined, and the target detection unit 115 acquires the bounding box as a detection result of the detection target. The detection result of the detection target is not limited to the example in which the detection result is acquired as the bounding box and may be acquired as the detection result in another form. The target detection unit 115 stores, in the second memory 104, the detection result 135 of the detection target acquired as the bounding box. In addition, assume that information about the bounding box acquired as the detection result 135 is information about, for example, the center position, width, and height of the bounding box.

Next, in step S504, the target detection unit 115 outputs the detection result 135 stored in the second memory 104. For example, the target detection unit 115 outputs, to the display unit 106, an image obtained by superimposing the bounding box that is the detection result 135 on the input image 122 and displays the image thereon.

In the present exemplary embodiment, an example in which the detection result is displayed to be used by a user is provided, but the usage of the detection result is not limited thereto. For example, the information processing apparatus may receive, via the communication unit 107, an image captured by an external image capturing apparatus, and may transmit the detection result 135, which is obtained by performing the target detection processing described above on the received image, to the image capturing apparatus from the communication unit 107. In this case, the image capturing apparatus can control autofocus to focus on a detection area indicated by the detection result 135.

With the information processing apparatus according to the first exemplary embodiment, because the training of the neural network 120 that preferentially suppresses erroneous detections that may occur on the same object including the detection target as a region is performed, it is possible to efficiently suppress erroneous detections that may cause a practical issue. Further, since the object area acquisition unit 111 according to the present exemplary embodiment performs simple processing of acquiring the object area including the detection target as a region based on the correct answer information 123 of the training data 121 at the time of training the neural network, it is possible to reduce a processing load at the time of training.

In the case of the first exemplary embodiment described above, the example is provided in which the object area acquisition unit 111 acquires the area of the object including the detection target as a region using the position and the size of the detection target in the correct answer information 123 as the parameters. In a second exemplary embodiment described below, an example is provided in which the area of the object including the detection target as a region can be accurately acquired by performing area division processing based on an image feature of an image area corresponding to the position and the size of the detection target in the correct answer information 123.

The configuration of an information processing apparatus according to the second exemplary embodiment is almost the same as that in FIG. 1 except that the information processing apparatus according to the second exemplary embodiment is provided with the area division unit 116. The area division unit 116 may be included in the object area acquisition unit 111. Functional units other than the area division unit 116 and the object area acquisition unit 111 are similar to those according to the first exemplary embodiment, and thus descriptions thereof are omitted.

In the present exemplary embodiment, the area division processing is processing of dividing an image into an area including a designated area and an area other than the area including the designated area based on an image feature of the designated area in the image, and the processing is sometimes referred to as a blob detection. There are many known techniques for the specific method of the area division processing, such as a graph cut. In the case of the present exemplary embodiment, assume that the area division unit 116 performs area division using the graph cut with the image area that is the detection target as a seed. The area division processing of an image using the graph cut is a method of dividing an input image into an area including a seed area and an area other than the seed area by an energy optimization based on the image feature of the given seed area. The area division processing is not limited to the area division processing using the graph cut, and various other area division methods may also be employed. These techniques are known techniques, and thus detailed descriptions thereof are omitted.

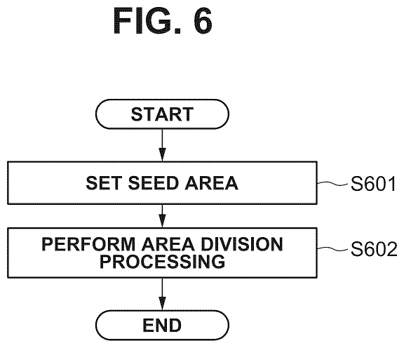

FIG. 6 is a flowchart illustrating a flow of the area division processing performed by the area division unit 116 according to the second exemplary embodiment.

First, in step S601, based on the position and the size of the detection target indicated by the correct answer information 123, the area division unit 116 sets a seed area on an image of the training data 121 set as the input image 122. As described above, in a case where the detection target is a face, a face area in the image is set as the seed area.

Next, in step S602, the area division unit 116 calculates, as the object area including the detection target, an area including an image feature similar to the seed area from the image in the training data 121 set as the input image 122. Then, the area division unit 116 divides the image in the training data 121 set as the input image 122 into an area determined as the object area and an area other than the object area using the graph cut with the detection target as the seed area. The object area acquisition unit 111 according to the second exemplary embodiment generates the object area map 127 with the map value “1” at each position in the area determined to be the object area by the graph cut and the map value “0” at each position in the area other than the object area, and the object area acquisition unit 111 stores the generated object area map 127 in the second memory 104

FIG. 3F is a diagram illustrating an example of the object area map 127 divided into the object area and the area other than the object area by the area division unit 116 and generated by the object area acquisition unit 111, in the examples in FIGS. 3A and 3B described above. The area with the value “1” at each position in the object area map 127 generated by the object area acquisition unit 111 according to the second exemplary embodiment may be dilated by dilation processing of the binary image. In this way, even if the area division processing has a minor error, it is possible to set the area in which erroneous detections are suppressed to be slightly wider.

As described above, the information processing apparatus according to the second exemplary embodiment can acquire the area of the object including the detection target as a region more accurately than that in the example according to the first exemplary embodiment, and it is possible to more efficiently suppress erroneous detections that can be an issue in practical use.

Embodiments of the present disclosure can also be realized by processing in which a program for implementing one or more functions of the above-described exemplary embodiments is supplied to a system or an apparatus via a network or a storage medium, and one or more processors in a computer of the system or the apparatus read and execute the program. Embodiments of the present disclosure can also be realized by a circuit (for example, an application specific integrated circuit (ASIC)) that implements one or more functions.

The above-described exemplary embodiments are merely examples of implementation for carrying out the present disclosure, and the technical scope of the present disclosure should not be interpreted in a limited manner by these exemplary embodiments. In other words, embodiments of the present disclosure can be implemented in various forms without departing from the technical idea or the main features thereof.

The disclosure of the present exemplary embodiments includes the following configurations, a method, and a storage medium.

According to the present disclosure, training that can efficiently suppress the occurrence of erroneous detections is enabled. Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-075283, which was filed on May 7, 2024 and which is hereby incorporated by reference herein in its entirety.

What is claimed is:

1. An information processing apparatus, comprising:
at least one processor; and
at least one memory that is in communication with the at least one processor,
wherein the at least one memory stores instructions for causing the at least one processor and the at least one memory to:
train a neural network for detecting an area of a detection target from an image using training data;
acquire an object area including the detection target as a region from the training data;
set a weighting area based on the object area including the detection target as a region; and
acquire a loss value based on a difference between a detection result by the neural network for the training data and the training data,
wherein, with regard to the difference between the detection result by the neural network and the training data, a second weight is applied to the difference in the weighting area to calculate the loss value, the second weight causing the loss value to be larger than a first weight applied to the difference outside the weighting area, and
wherein training of the neural network is performed based on the loss value.

2. The information processing apparatus according to claim 1, wherein the at least one memory further stores instructions for causing the at least one processor and the at least one memory to acquire the object area including the detection target as a region based on a position and a size of the detection target included in the training data.

3. The information processing apparatus according to claim 2, wherein the at least one memory further stores instructions for causing the at least one processor and the at least one memory to acquire, as the object area including the detection target as a region, an area having a size obtained by multiplying the size by a predetermined magnification ratio and with the position of the detection target included in the training data being set as a center.

4. The information processing apparatus according to claim 2, wherein the at least one memory further stores instructions for causing the at least one processor and the at least one memory to acquire an area having a positional relationship inferred from the position of the detection target included in the training data and having a proportional relationship that is larger relative to the size, as the object area including the detection target as a region.

5. The information processing apparatus according to claim 1, wherein the at least one memory further stores instructions for causing the at least one processor and the at least one memory to acquire the object area including the detection target as a region based on object area data set in association with the training data.

6. The information processing apparatus according to claim 1, wherein the at least one memory further stores instructions for causing the at least one processor and the at least one memory to:
divide an image included in the training data into an area including a position and a size of the detection target and an area other than the area based on information about the position and the size of the detection target included in the training data; and
acquire the area of the image divided by the dividing, the area including the position and the size of the detection target, as the object area including the detection target as a region.

7. The information processing apparatus according to claim 6, wherein the at least one memory further stores instructions for causing the at least one processor and the at least one memory to divide the image so that an area having an image feature similar to an image feature of the area set based on the position and the size of the detection target included in the training data is in the area including the position and the size of the detection target.

8. The information processing apparatus according to claim 6, wherein the at least one memory further stores instructions for causing the at least one processor and the at least one memory to acquire an area obtained by performing dilation processing on the area including the position and the size of the detection target as the object area including the detection target as a region.

9. The information processing apparatus according to claim 1, wherein the at least one memory further stores instructions for causing the at least one processor and the at least one memory to:
acquire an area with a difference between the detection result by the neural network in the weighting area and the training data being a predetermined threshold value or more; and
apply a third weight larger than the second weight to the area with the difference being the predetermined threshold value or more, to calculate the loss value.

10. The information processing apparatus according to claim 1, wherein the at least one memory further stores instructions for causing the at least one processor and the at least one memory to detect the detection target from an input image using the neural network.

11. An information processing method comprising:
training a neural network for detecting an area of a detection target from an image using training data;
acquiring an object area including the detection target as a region from the training data;
setting a weighting area based on the object area including the detection target as a region; and
acquiring a loss value based on a difference between a detection result by the neural network for the training data and the training data,
wherein, with regard to the difference between the detection result by the neural network and the training data, a second weight is applied to the difference in the weighting area to calculate the loss value, the second weight causing the loss value to be larger than a first weight applied to the difference outside the weighting area, and
wherein training of the neural network is performed based on the loss value.

12. A non-transitory computer-readable medium storing computer-executable instructions for causing a computer to:
train a neural network for detecting an area of a detection target from an image using training data;
acquire an object area including the detection target as a region from the training data;
set a weighting area based on the object area including the detection target as a region; and
acquire a loss value based on a difference between a detection result by the neural network for the training data and the training data,
wherein, with regard to the difference between the detection result by the neural network and the training data, a second weight is applied to the difference in the weighting area to calculate the loss value, the second weight causing the loss value to be larger than a first weight applied to the difference outside the weighting area, and
wherein training of the neural network is performed based on the loss value.
